(19) United States
(12) Patent Application Publication
(10) Pub. No.: US 2023/0021048 A1
(43) Pub. Date: Jan. 19, 2023

(54) VAPORISATION DEVICE FOR AN ELECTRONIC INHALER AND METHOD OF PRODUCING A VAPORISATION DEVICE

(71) Applicant: HAUNI MASCHINENBAU GMBH, HAMBURG (DE)

(72) Inventors: Frank GOLDSCHMIDTBÖING, ORTENBERG (DE); Uwe PELZ, SCHALLSTADT (DE); Muhannad GHANAM, FREIBURG (DE); Armin JAMALI, FREIBURG (DE); Eiko BÄUMKER, FREIBURG (DE); Mohamad REZA SABERI, FREIBURG (DE); Peter WOIAS, FREIBURG (DE); Thomas BILGER, BUGGINGEN (DE); Jan JAKLIN, FELLBACH (DE)

(21) Appl. No.: 17/781,971

(22) PCT Filed: Nov. 20, 2020
(86) PCT No.: PCT/EP2020/082894

§ 371 Date: Jun. 2, 2022

(30) Foreign Application Priority Data
Dec. 3, 2019 (DE) 10 2019 132 766.0

(51) Int. Cl. A24F 40/46; A24F 40/10; A24F 40/44; A24F 40/51

(52) U.S. Cl. CPC A24F 40/46; A24F 40/10; A24F 40/44; A24F 40/51

(57) ABSTRACT

The invention relates to a vaporisation device for an electronic inhaler, comprising a vaporiser having a thermally conductive substrate, wherein a plurality of continuous channels extend through the substrate from an inlet side to an outlet side of the substrate, and an electrical resistance heating element. The resistance heating element is arranged on one side of the substrate, consists of a material with higher electrical conductivity than the material of the substrate and has passage openings communicating with the channels of the substrate.

The present invention relates to a vaporisation device for an electronic inhaler, comprising a vaporiser having a thermally conductive substrate, wherein a plurality of continuous channels extend through the substrate from an inlet side to an outlet side of the substrate, and an electrical resistance heating element. The invention also relates to a method for producing such a vaporisation device.

Electronic cigarettes typically use a resistive heater to heat a wick material impregnated with liquid. Liquid vaporises both on the inner surface of the wick material and directly on the heater surface, with rough calculations showing that a large part of the vapour is generated in the wick material.

In wick-coil systems, the heating wire can have zones of greatly differing temperatures due to locally varying connections to the wick material and locally and temporally varying wetting with liquid. In particular, the effect of so-called hot spots, i.e. self-reinforcing local overheating, poses a problem, especially because the formation of pollutants increases sharply with temperature.

It is known to use a grid-like arrangement of heating wires (so-called mesh) instead of a wire coil. This has two main advantages. Firstly, the contact to the wick material is flat and therefore more defined, and secondly, the additional thermal conduction through the cross wires reduces the formation and/or development of hot spots. In practice, however, the grid wires are made of metal, so traces of this metal can dissolve in the vapour.

Another approach is to apply a metal heater to a porous ceramic as the wick material. The disadvantage of this approach is that the contact area between the heater and the ceramic is very defined, but is also very small. A high excess temperature is therefore required at the heater in order to transfer sufficient heat to the ceramic. This excess temperature in turn leads to increased formation of pollutants. If this is to be avoided, it is only possible at the expense of thermal inertia and would directly and disadvantageously affect vapour behaviour.

The volume heater according to WO 2018/083007 A1 uses a much more solid silicon plate instead of a grid. Holes are structured in this plate for vapour to escape. The thick plate ensures that temperature differences are equalised extremely quickly, so that hot spots cannot arise. In addition, the contact area is extremely flat and only interrupted by small holes, so that the thermal contact is significantly better than in a grid-like arrangement.

These advantages of the volume heater are counteracted by the disadvantage that there is essentially a cost problem. The resistance of the heater must be set extremely precisely and reproducibly. Since the entire silicon chip acts as a heating resistance, the specific resistance of the wafer material must be set by means of a precise dopant concentration. This is a technological challenge which leads to high material costs. Furthermore, the linear temperature coefficient of the wafer material is relatively low. However, the increase in resistance is evaluated in order to measure the heater temperature. The measurement sensitivity is therefore low. A material with a higher resistance coefficient would therefore be advantageous in order to achieve higher measurement sensitivity.

The object of the invention is to develop a heater which is cheaper to produce than the previously described volume heater without losing the advantages thereof.

The invention achieves this object with the features of the independent claims. According to the invention the resistance heating element is arranged on one side of the substrate, consists of a material with higher electrical conductivity than the material of the substrate and has passage openings communicating with the channels of the substrate. The vaporisation device according to the invention is characterised by a functional separation of heating element and substrate. The substrate has the function of a heat distribution body or a heat distribution plate. The advantage of this functional division is that the material and dimensions of the heating element and the substrate can each be selected and adapted specifically for the corresponding function (resistance heating or heat distribution).

The resistance heating element is preferably arranged on the outlet side of the substrate. An arrangement on the inlet side is also possible. In this case, electrical contact can be made with the resistance heating element, for example by soldering or sintering.

The temperature coefficient of the heating element is preferably greater than the temperature coefficient of the substrate. This advantage is particularly noticeable in a measuring circuit for determining the temperature of the heating element by measuring the resistance of the heating element, because the measurement sensitivity of the measuring circuit is increased significantly. The measurement sensitivity of a temperature measuring circuit which may be present is thus increased by the discussed feature.

A material with suitable conductivity, suitable temperature coefficient and suitable corrosion resistance is advantageously provided for the heating element. Gold, nickel and/or platinum are particularly suitable.

The substrate advantageously consists of silicon or contains silicon, in particular as the main component. Silicon as a substrate material has the advantage that it can be processed using microsystems technology methods and, in particular, the channels can be introduced into the substrate using proven technology, which promotes mass production of the vaporisation device.

The thickness of the substrate is preferably greater than the thickness of the heating element, which contributes to overall reduction of costs. This is because the heating element, which as a rule consists of a more expensive material than the substrate, can have a comparatively small thickness without the heating function being impaired as a result. The thickness of the heating element is advantageously less than 1 μm. The thickness of the heating element is advantageously less than the thickness of the substrate by a factor of at least 10.

Depending on the conductivity of the heating element and the desired heating resistance, the heating element can have a meandering structure in one embodiment, for example, or it can have a flat design in another embodiment. The electrical resistance can also be adjusted via the layer thickness of the heating element.

A wick element is preferably arranged on a side of the substrate facing away from the heating element. This leads to a particularly preferred functional three-way division: heating (heating element)-heat distribution (substrate)-capillary liquid transport (wick element) of the vaporiser device. The wick material can advantageously be made of glass fibre fleece, porous ceramics, metal foam, an open-pored material or another suitable capillary transporting material.

An electrical insulation layer can preferably be arranged on a surface of the substrate facing the heating element, in order to improve the functional separation of the insulation layer, in particular from a conductive substrate. The insulation layer is preferably formed by a passivation of the substrate, so that a complex application of the insulation layer to the substrate can be omitted.

An adhesive layer, in particular a metallic one, can preferably be provided between the heating element and the substrate or the insulation layer, in order to improve the adhesion of the heating element to the substrate.

Insulation, for example made of silicon oxide, silicon carbide and/or silicon nitride, is preferably provided on a surface of the heating element in order to produce a metal-free surface.

The object is also achieved by a method for producing a vaporisation device according to the invention, wherein the heating element is applied to the substrate according to the invention by vapour deposition, sputtering or screen printing. The channels of the substrate can advantageously be produced using proven microsystems technology, in particular lithography and dry etching. The invention is not limited to clean room manufacture of the heating element.

The invention will be explained below on the basis of preferred embodiments with reference to the accompanying drawings. In the drawings:

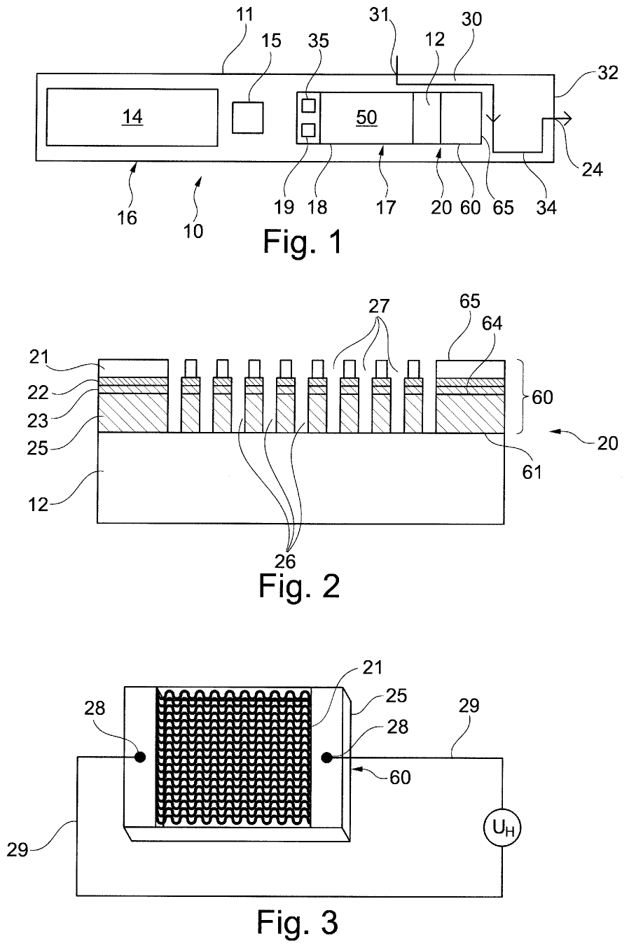

FIG. 1 is a schematic view of an electronic inhaler;

FIG. 2 is a cross-sectional view of a layer structure of a vaporisation device according to the invention; and

FIG. 3 is a plan view of the outlet side with heating element of a vaporisation device according to the invention.

The inhaler 10, in this case an electronic cigarette product, comprises a housing 11 in which an air channel 30 is provided between at least one air inlet opening 31 and one air outlet opening 24 at a mouth end 32 of the cigarette product 10. The mouth end 32 of the cigarette product 10 is the end on which the consumer puffs for the purpose of inhalation and thereby applies a negative pressure to the cigarette product 10 and generates an air flow 34 in the air channel 30.

The inhaler 10 advantageously consists of a base part 16 and a consumption unit 17 which comprises the vaporisation device 20 and the liquid reservoir 18 and is in particular in the form of a replaceable cartridge. The air sucked in through the inlet opening 31 is guided in the air duct 30 to, through, or along the vaporisation device 20. The vaporisation device 20 is connected or can be connected to the liquid reservoir 18 in which at least one liquid 50 is stored. The vaporisation device 20 vaporises liquid 50, which is supplied thereto from the liquid reservoir 18, and adds the vaporised liquid as aerosol/vapour to the air stream 34 at an outlet side 65. An advantageous volume of the liquid reservoir 18 is in the range between 0.1 ml and 5 ml, preferably between 0.5 ml and 3 ml, more preferably between 0.7 ml and 2 ml or 1.5 ml.

The electronic cigarette 10 also comprises an electrical energy store 14 and an electronic control device 15. The energy store 14 is usually arranged in the base part 16 and can be, in particular, a disposable electrochemical battery or a rechargeable electrochemical battery, for example a lithium-ion battery. In the example shown in FIG. 1, the energy store 14 is arranged in a part of the inhaler 10 facing away from the mouth end 32. The consumption unit 17 is advantageously arranged between the energy store 14 and the mouth end 32. The electronic control device 15 comprises at least one digital data processing apparatus, in particular a microprocessor and/or microcontroller, in the base part 16 (as shown in FIG. 1) and/or in the consumption unit 17.

A sensor, such as a pressure sensor or a pressure switch or flow switch, is advantageously arranged in the housing 11, the control device 15 being able to detect, on the basis of a sensor signal output by the sensor, that a consumer is puffing on the mouth end 32 of the cigarette product 10 in order to inhale. In this case, the control device 15 actuates the vaporisation device 20, in order to add liquid 50 from the liquid reservoir 18 into the air stream 34 as aerosol/vapour.

The liquid 50 which is to be dosed and is stored in the liquid reservoir 18 is, for example, a mixture comprising one or more of the following components: 1,2-propylene glycol, glycerin, water, at least one aroma (flavour), optionally an active ingredient, for example nicotine.

The vaporisation device 20 comprises at least one vaporiser 60 with at least one resistance heating element 21 (see FIG. 2) and a wick element 12 for supplying liquid 50 from the liquid reservoir 18 to the vaporiser 60. Due to the ohmic resistance, a current flow through the electrically conductive heating element 21 leads to heating thereof and therefore to vaporisation of liquid in contact with the heating element 21. The vapour/aerosol generated in this manner escapes to the outlet side 65 from the vaporiser 60 and is added to the air flow 34, see FIG. 1. The vaporisation temperature is preferably in the range between 100° C. and 450° C., more preferably between 150° C. and 350° C., even more preferably between 190° C. and 290° C.

The consumption unit 17 and/or the base part 16 advantageously comprises a non-volatile data memory 35 for storing information or parameters relating to the consumption unit 17. The data memory 35 can be part of the electronic control device 15. The data memory is advantageously used to store information regarding the composition of the liquid stored in the liquid reservoir 18, information regarding the process profile, in particular power/temperature control; data for condition monitoring or system testing, for example leak testing; data regarding copy protection and counterfeit protection, an ID for unique identification of the consumption unit 17, serial number, production date and/or expiry date, and/or number of puffs (number of inhalation puffs by the consumer) or the period of use. Advantageously, the data memory is or can be electrically connected to the control unit 15.

A preferred embodiment of a vaporisation device 20 according to the invention is shown in FIGS. 2 and 3. The vaporiser 60 comprises an electrically conductive, in particular metallic, resistance heating element 21 and a thermally conductive substrate 25, which advantageously form a layer system. The substrate 25 is advantageously a solid body and has a plurality of channels 26 continuously extending from an inlet side 61 of the substrate 25 to an outlet side 64 of the substrate 25 to allow liquid transport from the inlet side 61 to the outlet side 64. Optional layers 22, 23 (these will be explained later) of the vaporiser 60 between the substrate 25 and the heating element 21 expediently have corresponding through-openings.

The substrate 25 advantageously consists of a material with high thermal conductivity. Particularly advantageously, the substrate 25 is made of silicon, or silicon forms the main component of the substrate 25. Silicon as a substrate material has the advantage that it can be processed using microsystems technology methods and, in particular, the channels 26 can be introduced into the substrate 25. In addition to monocrystalline silicon, significantly more favourable polycrystalline silicon can also be used. Doped, preferably slightly doped, or undoped silicon can be used.

The substrate 25 is preferably manufactured on the basis of MEMS technology, in particular from silicon, and is therefore advantageously a micro-electromechanical system. The substrate 25 can advantageously be made from portions of a wafer. The thickness of the substrate 25, and thus the length of the channels 26, advantageously corresponds to the thickness of conventional wafers and is preferably at most 1000 μm, more preferably at most 750 μm, even more preferably at most 500 μm. The thickness of the substrate 25, and thus the length of the channels 26, is preferably at least 100 μm, more preferably at least 200 μm and even more preferably at least 300 μm.

The resistance heating element 21 is advantageously arranged in the form of a heating layer on the outlet side 64 of the substrate 25 and covers the substrate 25 on the outlet side 64 completely or at least in the area of the outlet openings of the channels 26. The resistance heating element 21 is metallic and advantageously consists of a material with high electrical conductivity, a high temperature coefficient and/or high corrosion resistance. The material preferably comprises gold, nickel and/or platinum including their alloys. Gold, nickel or platinum is advantageously the main component of the material of the resistance heating element 21. In a particularly advantageous embodiment, the resistance heating element 21 consists of gold. The resistance heating element 21 has passage openings 27 which communicate with the channels 26 of the substrate 25, i.e. are connected in a liquid-conducting manner, so that liquid can flow from the inlet side 61 to the outlet side 65 of the vaporiser 60.

The resistance heating element 21 has a typical thickness in the range between 50 nm and 500 nm and is advantageously applied to the substrate 25 by vapour deposition, sputtering or metallic screen printing. A heating element 21 in the form of a coating of the substrate 25 with approx. 300 nm of platinum would be suitable, for example, for achieving a resistance of approx. 1 Ω with a heater area of 3 mm×2 mm. The thickness of the resistance heating element 21 is advantageously at least a factor of 10, more advantageously at least a factor of 100 less than the thickness of the substrate 25.

Depending on the conductivity of the heating element 21 and the desired heating resistance, it can be advantageous to structure the heating element 21 in a meandering manner, as shown in FIGS. 2 and 3. In another embodiment, the heating element 21 can be provided over the entire surface (apart from the passage openings 27).

The electrical conductivity of the resistance heating element 21 is higher, advantageously by a factor of at least 10, more advantageously by a factor of at least 100, even more advantageously by a factor of at least 1000, than the electrical conductivity of the substrate 25. For example, the electrical conductivity (at 0° C.) of gold (heating element 21) is 48.8 MS/m and of silicon (substrate 25) is less than 0.01 MS/m. Accordingly, the electrical resistance of the substrate 25 is higher by a factor of at least 10 (or 100 or 1000) than the electrical resistance of the resistance heating element 21.

In order to achieve a metal-free surface of the resistance heating element 21, this element can be passivated with a silicon dioxide layer, for example.

A wick element 12 is advantageously arranged on the inlet side 61 of the substrate 25, which wick element can supply liquid from the liquid reservoir 18 to the vaporiser 60 by means of capillary force and can track it in the event of vaporisation. The wick element 12 is advantageously connected in a contacting manner to the inlet side 61 of the vaporiser 60 or of the substrate 25 and advantageously covers the inlet side 61 of the vaporiser 60 or of the substrate 25 completely or at least in the region of the inlet openings of the channels 26. Glass fibre fleece is used particularly advantageously as the wick material, but porous ceramics, metal foam or the like can also be used as the material for the wick element 25.

A heating voltage Uh is applied to the resistance heating element 21 in order to vaporise liquid in the vaporiser 60. For this purpose, electrical contacts 28 are provided on the heating element 21, and are connected to the heating voltage source Uh via electrical lines 29, see FIG. 3. Due to the high electrical conductivity of the resistance heating element 21, the heating voltage Uh leads to rapid and effective heating of the resistance heating element 21, wherein the electrical heating energy required for this comes from the energy store 14. The heat is quickly transferred into the substrate 25 due to the surface contact between the heating element 21 and the substrate 25. Due to the good thermal conductivity of the substrate 25, the heat can be distributed quickly in the substrate. As a result, the entire vaporiser 60 including the substrate 25 can vaporise liquid, so that the vaporiser 60 has an excellent degree of reproducible efficiency and a very high vapour rate.

According to what has been said above, the vaporisation device 20 is characterised by a functional separation (three-way division here) with the heating element 21, the substrate 25 and advantageously the wick element 12. The substrate 25 has the function of a heat distribution body or a heat distribution plate. The advantage of this functional division is that the material and dimensions of the components 21, 25 can each be selected and adapted specifically for the corresponding function (resistance heating or heat distribution).

The vaporisation device 20 can advantageously have a measuring circuit 19 for determining the temperature of the heating element 21 by measuring the resistance of the heating element 21. The temperature coefficient of the heating element 21 is advantageously greater, in particular by at least a factor of two, more advantageously by at least a factor of three, than that of the substrate 25. This leads to a significant increase in the measurement sensitivity of the measuring circuit 19. For example, the temperature coefficient (at 0° C.) of gold (heating element 21) is 0.0037/K, that of silicon can have very different factors depending on the temperature range and doping and can be around 0.001/K in some embodiments.

The heating element 21 can be bonded to the substrate via a metallic adhesive layer 22, for example made of Ti or a Ti alloy. If sufficient adhesion of the heating element 21 can be achieved without an adhesive layer 22, this is unnecessary.

If the substrate 25 is electrically conductive, an electrical insulation layer 23 can be provided between the substrate 25 and the heating element 21 (possibly the adhesive layer 22). The insulation layer 23 can advantageously be a passivation layer on the substrate 25. For example, with a higher doping of a silicon substrate 25, a passivation layer 23 made of silicon oxide and/or silicon nitride, preferably with a thickness in the range between 50 nm and 500 nm, would be advantageous.

If the substrate 25 is electrically non-conductive or has only a very low conductivity, an electrical insulation layer 23 may be unnecessary. For example, with low doping or an undoped silicon substrate 25, the conductivity of the silicon is negligible compared to that of the heating element 21, so that no electrical insulation layer 23 is required.

The average diameter of the channels 26 of the substrate 25 is preferably in the range between 5 μm and 200 μm, more preferably in the range between 30 μm and 150 μm, even more preferably in the range between 50 μm and 100 μm. Due to these dimensions, a capillary action is advantageously produced, so that liquid penetrating into a channel 26 at the inlet side 61 rises upwards through the channel 26 until the channel 26 is filled with liquid. The number of channels 26 is preferably in the range between 4 and 1000. The channels 26 are advantageously arranged in the form of an array. The array can be in the form of a matrix having s columns and z rows, s advantageously being in the range between 2 and 50 and more advantageously in the range between 3 and 30, and/or z advantageously being in the range between 2 and 50 and more advantageously in the range between 3 and 30.

1-16. (canceled)

17. A vaporisation device for an electronic inhaler, comprising:
a vaporiser having a thermally conductive substrate, wherein a plurality of continuous channels extend through the substrate from an inlet side of the substrate to an outlet side of the substrate, and
an electrical resistance heating element, wherein the electrical resistance heating element is arranged on either the inlet side of the substrate or the outlet side of the substrate, wherein an electrical conductivity of the electrical resistance heating element is higher than an electrical conductivity of the substrate and wherein the electrical resistance heating element has a plurality of passage openings communicating with the plurality of continuous channels of the substrate.

18. The vaporisation device according to claim 17, wherein a temperature coefficient of the electrical resistance heating element is greater than a temperature coefficient of the substrate.

19. The vaporisation device according to claim 17, wherein the electrical resistance heating element comprises one or more of the following components: gold, nickel, and platinum.

20. The vaporisation device according to claim 17, wherein the substrate consists of silicon or contains silicon.

21. The vaporisation device according to claim 17, wherein a thickness of the substrate is greater than a thickness of the heating element.

22. The vaporisation device according to claim 17, wherein a thickness of the heating element is less than 1 μm and/or is less than a thickness of the substrate by a factor of at least 10.

23. The vaporisation device according to claim 17, wherein the electrical resistance heating element has a meandering structure or has a flat design.

24. The vaporisation device according to claim 17, wherein a wick element is arranged on either the inlet side of the substrate or the outlet side of the substrate remote from the electrical resistance heating element.

25. The vaporisation device according to claim 24 wherein the wick element is made of glass fibre fleece, cellulose fibre, porous ceramic, metal foam, an open-pored material.

26. The vaporisation device according to claim 17, wherein an adhesive layer is provided between the electrical resistance heating element and the substrate.

27. The vaporisation device according to claim 26, wherein the adhesive layer is metallic.

28. The vaporisation device according to claim 17, wherein an electrical insulation layer is arranged on a surface of the substrate facing the electrical resistance heating element.

29. The vaporisation device according to claim 28, wherein the electrical insulation layer is formed by a passivation of the substrate.

30. The vaporisation device according to claim 17, wherein insulation is provided on a surface of the electrical resistance heating element.

31. The vaporisation device according to claim 17, wherein the insulation is made of silicon oxide, silicon carbide and/or silicon nitride.

32. A method for producing a vaporisation device according to claim 17, comprising applying the heating element to the substrate by vapour deposition, sputtering, or screen printing.

33. The method according to claim 32, wherein the channels of the substrate are produced via microsystems technology.

34. The method according to claim 33, wherein the channels of the substrate are produced via lithography and dry etching.
